(19) United States
(12) Patent Application Publication
(10) Pub. No.: US 2009/0188479 A1
(43) Pub. Date: Jul. 30, 2009

(54) ARRANGEMENT AND METHOD TO OPERATE A COMBUSTION ENGINE WITH TWO DIFFERENT TYPES OF FUEL

(75) Inventor: Elmar Haudel, Wiesbaden (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/280,960

(22) PCT Filed: Feb. 26, 2007
(86) PCT No.: PCT/EP2007/001622

§ 371 Date: Dec. 29, 2008

(30) Foreign Application Priority Data
Feb. 27, 2006 (DE) 102006008902.2

(51) Int. Cl. F02B 69/04

(52) U.S. Cl. 123/575

(57) ABSTRACT

An arrangement and a method are provided for a combustion engine which can be powered with a first and a second type of fuel and the first type of fuel can sufficiently lubricate the valve seating of the combustion engine. The arrangement includes, but is not limited to two fuel circuits that are at least partially allocated to the different types of fuel as well as at least one electronic control device, which controls the operation of the combustion engine with the first type of fuel and also with the second type of fuel. The operation of the combustion engine is controlled in a way that the first type of fuel is fed to the combustion engine in selectable intervals.

### CROSS-REFERENCE TO RELATED APPLICATIONS

This application is a U.S. National-Stage entry under 35 U.S.C. § 371 based on International Application No. PCT/EP2007/001622, filed Feb. 26, 2007, which was published under PCT Article 21(2) and which claims priority to German Application No. 102006008902.2, filed Feb. 27, 2006, which are all hereby incorporated in their entirety by reference.

### TECHNICAL FIELD

The technical field generally relates to combustion engines and, more particularly relates to an arrangement for a combustion engine which can be powered with two different types of fuels.

### BACKGROUND

Against the background of diminishing oil reserves and risen exhaust emission requirements, modern vehicles are increasingly equipped with combustion engines that work, similar to Otto engines, according to the four-stroke principle and, besides gas, can also be driven with LPG.

As gas fuels primarily liquefied petroleum gases are used, the so-called LPG (Liquified Petroleum Gas) is a byproduct from the hydrogenation of oil refining processes. LPG primarily consists of propane and butane, and Compressed Natural Gas (CNG), which mainly consists of methane and is obtained from the production of compressed natural gas. Because LPG and CNG contain no sulfur and lead compounds and have very good combustion characteristics with an excellent mixture admission, the pollutant emission of CO, HC, NOx and CO2 is lower than with motors that are exclusively driven with gas.

Because the net of gas stations for LPG or CNG is not yet sufficiently developed in industrialized countries, most of the vehicles powered with LPG can today be powered in a “bivalent” mode (i.e., the vehicles are equipped with both a fuel system for gas and LPG). If required, it is possible to switch automatically or manually into the respective operation mode via a controlling device. It is widely known that in such bivalent vehicles, the automatic switch from LPG to gas is carried out as soon as the filling level of the LPG tank falls below a particular threshold. Additionally, vehicles driven with LPG are usually started with gas since with cold engines or cold cooling water circuits it is not possible to achieve a satisfying mixture preparation. As soon as a certain operating temperature has been reached, it is automatically switched into the LPG mode.

One further problem of operating combustion engines with LPG is that the valve seating is exposed to higher strains than in the pure gas operation mode due to the lacking and/or missing lubricating ability of the gaseous fuels LPG/CNG. If the lubricating ability of gas is taken as the reference value of 100%, then the relative lubricating ability of LPG amounts to approximately 20%, while the relative lubricating ability of CNG amounts to practically 0%.

To solve this problem, add-on kits are already sold which supply the valve seating with additional lubricants. To be more precise, such an add-on kit contains a storage tank to store the lubricant and a lubricant line from the storage tank to the inlet duct in order to continuously feed the lubricant to a small nozzle that is installed behind the throttle body in the intake manifold. The storage tank is installed in the engine bay. Consequently, it is possible to suck in a preset amount of lubricant according to the Venturi principle.

An unfavorable feature of the above specified solution to the problem is the fact that costs occur for purchasing and installing the add-on kit as well as for purchasing the lubricant. Furthermore, constructed space must be available mainly for the installation of the lubrication storage tank. Beyond that, it cannot be excluded that, due to the fed-in lubricant, the combustion characteristics deteriorate and problems occur in the catalyst system.

However, it is at least one task of the present invention to provide an arrangement and a method to operate bivalent combustion engines (in a technical sense) that ensure an appropriate lubrication of the valve seating without relying on additionally feeding in additional lubricants, since this has usually negative impacts. In addition, other tasks, desirable features and characteristics will become apparent from the subsequent summary and detailed description, and the appended claims, taken in conjunction with the accompanying drawings and this background.

According to an embodiment of the invention, an arrangement is provided for a combustion engine that is drivable with two different types of fuel, particularly for driving a vehicle. This combustion engine comprises two fuel circuits, which are at least partially allocated to the different types of fuel, and at least an electronic control system to control the operation of the combustion engine with both the first type of fuel and the second type of fuel. Of the two types of fuel, the first one is chosen or prepared in a way that can sufficiently lubricate the valve seating without making it necessary to add additional lubricants.

The arrangement according an embodiment of the invention is primarily characterized in that the control device is suitable for controlling the operation of the combustion engine in a way that the first type of fuel of the combustion engine is fed in during selectable, particularly periodic intervals in order to sufficiently lubricate the valve seating.

During the operation of the combustion engine with the second type of fuel it is possible that the addition of the second type of fuel is interrupted during selectable, particularly periodic intervals in order to exclusively feed in the first type of fuel to the combustion engine during these intervals.

Because, after the addition of the first type of fuel has stopped, the valve seating are still being lubricated for some time during such an interval, it is possible to achieve a sufficient lubrication of the valve seating during the exclusive addition of the second type of fuel. Precondition for that is that the distances and lengths of the intervals for the feeding in of the first type of fuel are chosen in a way that, after discontinuing the addition of the first type of fuel, there is always a sufficient lubrication at the valve seating due to the first type of fuel.

Alternatively, it is also possible that, during the operation of the combustion engine with the second type of fuel, the first type of fuel is fed in to the combustion engine in addition to the second type of fuel during selectable, particularly periodic intervals. Due to the at least substantially simultaneous addition of the first and second type of fuel during the selectable intervals, it is possible to achieve a sufficient lubrication of the valve seating both during the selectable intervals and during the exclusive addition of the second type of fuel after discontinuing the addition of the first type of fuel. Precondition for that is that the distances and lengths of the intervals for the additional feed in of the first type of fuel are chosen in such a way that, after discontinuing the addition of the first type of fuel, there is a sufficient lubricating effect at the valve seating due to the first type of fuel.

Ideally, but not imperatively, the combustion engine should be a combustion engine with extraneous ignition.

The distances and lengths of the selectable, particularly periodic intervals to feed in the first type of fuel can, for instance, be specified by time periods or the total rotations of the combustion engine. In particular, the distances und lengths of the intervals depend on the dimensioning and the operation mode of the combustion engine. For example, after every 10000 rotations of the combustion engine operated with the second type of fuel, counted from a certain reference time, it is possible to exclusively or additionally operate the combustion engine with the first type of fuel for 100 to 1000 rotations in order to achieve a sufficient lubrication of the valve seating.

In an exemplary embodiment according to the invention, (common) gas is used as the first type of fuel and, LPG as the second type of fuel. With an additional embodiment of the according to the invention (common) gas is used as the first type of fuel and CNG as the second type of fuel. In this case, it is possible to achieve the sufficient lubrication of the valve seating if, in case the combustion engine is operated with LPG or CNG, during periodic intervals gas is fed in to the combustion engine in order to achieve a sufficient lubrication at the valve seating. The addition of LPG/CNG can be interrupted during the addition of gas.

Furthermore, an embodiment of the invention relates to an electronic control device for a combustion engine that is drivable with two different types of fuel, particularly for powering a vehicle, whereby the arrangement comprises at least two fuel circuits that are at least partially allocated to the different types of fuel. The first type of fuel provides for a sufficient lubrication of the valve seating.

The electronic control device controls the operation of the combustion engine with both the first type of fuel and the second type of fuel and is suitable for controlling the operation of the combustion engine in a way that the first type of fuel of the combustion engine is fed in during selectable, particularly periodic intervals. Here, it is possible that, during the operation of the combustion engine with the second type of fuel, the addition of the second type of fuel is interrupted during selectable, particularly periodic intervals in order to feed in only the first type of fuel to the combustion engine during these intervals. Alternatively, it is also possible that, during the operation of the combustion engine with the second type of fuel, during selectable, particularly periodic intervals the first type of fuel is fed in to the combustion engine in addition to the second type of fuel.

Furthermore, an embodiment of the invention relates to a vehicle with an apparatus as described above for operating a combustion engine with two different types of fuel.

Additionally, an embodiment of the invention relates to a method for operating a combustion engine with a first type of fuel and a second type of fuel, particularly for powering a vehicle, whereby the first type of fuel has a sufficient lubricating ability for the valve seating of the combustion engine. The method is characterized in that the first type of fuel of the combustion engine is fed in during selectable, particularly periodic intervals in order to lubricate the valve seating sufficiently. Here, it is possible that, during the operation of the combustion engine with the second type of fuel, the addition of the second type of fuel is interrupted during selectable, particularly periodic intervals in order to feed in only the first type of fuel to the combustion engine during these intervals. Alternatively, it is also possible that, during the operation of the combustion engine with the second type of fuel, during selectable, particularly periodic intervals the first type of fuel is fed in to the combustion engine in addition to the second type of fuel.

Additionally, an embodiment of the invention relates to a source code for an electronic control device suitable for processing data of an apparatus as described above for powering a combustion engine with two different types of fuel. This source code contains control commands that prompt the control device to carry out a method as described above.

Additionally, an embodiment of the invention relates to a storage medium with the relevant source code stored on it.

### BRIEF DESCRIPTION OF THE DRAWINGS

The present invention will hereinafter be described in conjunction with the following drawing FIGURE(s), wherein like numerals denote like elements, and

FIG. 1 a schematic representation of an embodiment of the invention for alternately operating a combustion engine of a vehicle with two different types of fuel.

### DETAILED DESCRIPTION

The following detailed description is merely exemplary in nature and is not intended to limit application and uses. Furthermore, there is no intention to be bound by any theory presented in the preceding summary or background or the following detailed description.

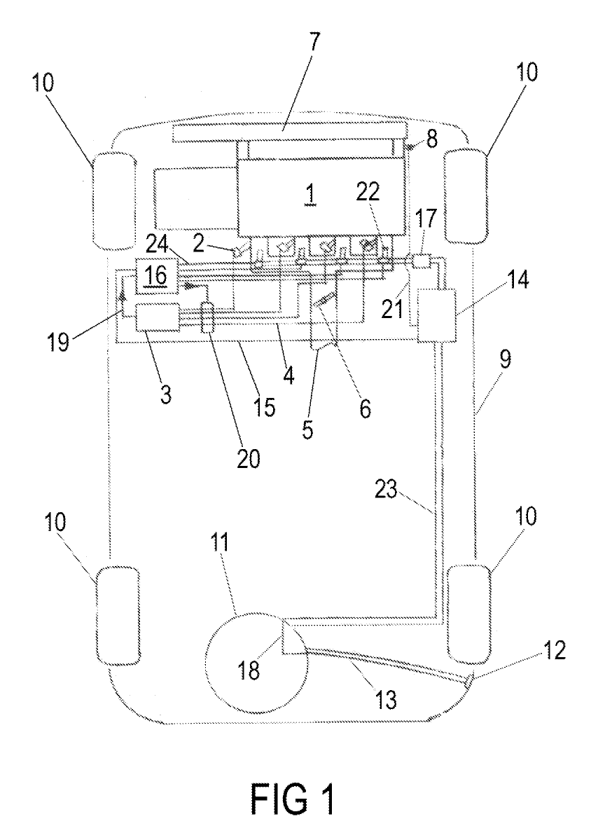

Referring to FIG. 1, in which, according to an embodiment of the invention is shown in a schematic drawing for operating a combustion engine of a bivalent vehicle, which can be powered with gas and LPG. As can be seen in this drawing, a vehicle comprises one motor 1 with an externally-supplied ignition, in which gas can be injected in the combustion chambers of cylinders (not described in detail) via gas injection valves 2. An engine control unit 3 is connected to the gas injection valves 2 via electronic connecting cables 4 and controls the opening and closing of the gas injection valves 2. Via an inlet manifold 5 (partially pictured), which contains a throttle body 6, gas is fed to the gas injection valves 2. Because it is not necessary for understanding, further components of the gas-fuel circuit and additional components of the gas-mixture preparation are not described in more detail. Additionally, a cooler 7 with water temperature sensor 8 is provided. To indicate the relative position of the components within the vehicle the vehicle profile 9 and the wheels 10 are specified.

Now, it follows a description of the LPG supply device. The LPG supply device comprises an LPG tank 11, which is connected to a fuelling valve 12 via a connecting cable 13, in order to ensure that it can be filled with LPG from the outside. The LPG tank 11 is connected to an LPG supply line 23 by means of a multi/safety valve 18. The LPG supply line 23 is connected to a vaporizer 14 with an integrated pressure controller. This vaporizer changes the state of aggregation of the LPG from liquid to gaseous. The vaporizer 14 is connected with a plurality of gas injectors 22 via a gas filter 17. By means of the gas injectors 22, it is possible to inject the gaseous fuel (LPG) into the intake duct of the cylinders of Motor 1. The thermal connection of the vaporizer 14 to the cooling circuit of the vehicle is not specified. The vaporizer 14 is connected with an electrical LPG control device 16 via an electrical connecting cable 15. The LPG control device 16 controls the vaporizer 14. Additionally, the vaporizer 14 is connected with the water temperature sensor 8 via an electrical connecting cable 21.

In the arrangement as depicted in FIG. 1, the electrical LPG control device 16 which is connected to the gas injectors 22 via electrical connecting cables 24 is connected with the engine controller unit 3 via an electrical connecting cable 19. Furthermore, the LPG control device 16 is conductively connected with a tap 20 for the output signals of the engine control unit 3. The electronic LPG control device 16 and the engine control unit 3 are programmed in a way that gas and LPG are alternately added to the Motor 1 in periodic intervals. To be more precise, the feeding of LPG to the Motor 1 according to selectable, periodic intervals is interrupted to only feed in gas during these intervals and thereby to achieve a sufficient lubrication of the valve seating. For instance, and by way of example only, after every 10000 rotations of the Motor 1 operated with LPG, for 100 to 1000 rotations it is possible to operate the motor with LPG to achieve a sufficient lubrication of the valve seating.

The engine control unit 3 and the LPG control device 16 can also be integrated in one single control unit, which is then programmed in the relevant way.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A combustion engine for a vehicle, the combustion engine powered with a first type of fuel and a second type of fuel, comprising:
at least two fuel circuits at least partially allocated to the first type of fuel and second type of fuel; and
at least one electronic control device adapted to control an operation of the at least two fuel circuits to feed the first type of fuel to the combustion engine during selectable intervals.

2. The combustion engine according to claim 1,
wherein only the first type of fuel is fed to the combustion engine during the selectable intervals.

3. The combustion engine according to claim 1,
wherein the first type of fuel and the second type of fuel are at least substantially simultaneously fed to the combustion engine during the selectable intervals.

4. The combustion engine according to claim 1,
wherein the first type of fuel is Gas and the second type of fuel is Liquified Petroleum Gas (LPG).

5. The combustion engine according to claims 1,
wherein the first type of fuel is Gas and the second type of fuel is Compressed Natural Gas (CNG).

6. The combustion engine according to claim 1,
wherein the selectable intervals are prescribed as time periods.

7. The combustion engine according to claims 1,
wherein the selectable intervals are prescribed as rotations of the combustion engine.

8. (canceled)

9. A method for operating a combustion engine for a vehicle, the combustion engine powered with a first type of fuel and a second type of fuel, comprising the steps of:
feeding the second type of fuel to the combustion engine; and
feeding the first type of fuel to the combustion engine during the selectable intervals.

10. The method according to claim 9,
further comprising the steps of ceasing to feed the second type of fuel to the combustion engine during the selectable intervals.

11. The method according to claim 9,
wherein the first type of fuel and the second type of fuel are substantially simultaneously fed to the combustion engine during the selectable intervals.

12. The method according to one of the claims 9,
wherein gas is the first type of fuel and the second type is fuel Liquified Petroleum Gas (LPG).

13. The method according to claims 9,
wherein gas is the first type of fuel and the second type of fuel is Compressed Natural Gas (CNG).

14. The method according to claim 9,
wherein the selectable intervals are specified as time periods.

15. The method according to one of the claim 9,
wherein the selectable intervals are specified as rotations of the combustion engine.
